(19) United States
(12) Patent Application Publication
(10) Pub. No.: US 2015/0356557 A1
(43) Pub. Date: Dec. 10, 2015

(54) PAYMENT AUTHORIZATION MESSAGE FOR USE WITH TRANSACTIONS OF ELECTRICAL ENERGY FOR ELECTRICALLY-POWERED VEHICLES

(71) Applicant: MasterCard International Incorporated, Purchase, NY (US)

(72) Inventor: TIMOTHY MCKINNEY, Old Greenwich, CT (US)

(21) Appl. No.: 14/731,597

(22) Filed: Jun. 5, 2015

Related U.S. Application Data
(60) Provisional application No. 62/010,179, filed on Jun. 10, 2014.

(51) Int. Cl. G06Q 20/40; G06Q 20/30

(52) U.S. Cl. CPC G06Q 20/40; G06Q 20/30

(57) ABSTRACT

In one aspect of the subject disclosure, a payment authorization message is provided which is formatted to be transmitted over a payment network, the payment authorization message including data elements representing units of electrical power sent to, or transmitted from, an electrically-powered vehicle.

### CROSS-REFERENCE TO RELATED APPLICATION

This application claims priority to U.S. Provisional Patent Application No. 62/010,179, filed Jun. 10, 2014, the entire contents of which are incorporated by reference herein.

### BACKGROUND OF THE DISCLOSURE

Electrically-powered vehicles, including hybrids and fully electrically-powered vehicles, are becoming more commonplace in the world. To allow for away-from-home charging, “pay as you go” charging stations have been developed

In addition, it has been suggested that electrical power stored in a vehicle can be transmitted back into the power supply grid. This allows for a commodity-type market to be developed for electrical power for electrically-powered vehicles whereby consumers may purchase and sell electricity under different conditions, such as times of day and locations, resulting in electricity being bought and sold at different prices. SAE International has been developing a standard SAE J2847/1, “Communication between Plug-in Vehicles and the Utility Grid”, which seeks to set a range of standards for energy transfer between an electrically-powered vehicle and a grid (both transfer to the vehicle from the grid and vice versa). ISO and IEC have been preparing a similar range of standards, ISO/IEC 15118, “Road vehicles—Vehicle to grid communication interface.” Tax benefits, such as credits, may be also available to those participating in such a system.

### SUMMARY OF THE DISCLOSURE

In one aspect of the subject disclosure, a payment authorization message is provided which is formatted to be transmitted over a payment network, the payment authorization message including data elements representing units of electrical power sent to, or transmitted from, an electrically-powered vehicle.

In a further aspect of the subject disclosure, a buy/sell system is provided herein for electrical power for electrically-powered vehicles. This system includes an interface for coupling with an electrically-powered vehicle, the interface allowing for two-way flow of electricity to and from an electrically-powered vehicle coupled with the interface. The system also includes a controller for receiving data elements formatted to be transmitted with a payment authorization message over a payment network, the data elements representing units of electrical power sent to, or transmitted from, an electrically-powered vehicle coupled with the interface. Advantageously, with the subject disclosure, a system is provided whereby buy and sell transactions of electrical power for electrically-powered vehicles may be tracked over a payment network.

As used herein, a “payment network” refers to a network or system such as the systems operated by MasterCard International Incorporated, or other networks, which electronically process payment transactions on behalf of a number of merchants, acquirers, issuers and card holders. The payment network acts as intermediary between a combination of these parties, such as between acquirers and issuers. The payment network may include a network of operatively linked computer processing units (CPU's).

As used herein, a “payment authorization message” refers to a compilation of data elements in electronic form formatted to be transmitted over a payment network. The message may be processed in accordance with payment network methods and equipment. In addition, the message may be in the form of a request sent to initiate a financial transaction by a consumer or merchant, with the request being forwarded ultimately, via the payment network, to the issuer of the related payment instrument, including passing through any acquirer as necessary. The message may be formatted in accordance with known standards, such as ISO 8583.

These and other features of the disclosure will be better understood through a study of the follow detailed description and accompanying drawings.

### BRIEF DESCRIPTION OF THE DRAWINGS

FIG. 1 is a schematic showing a system in accordance with the subject disclosure; and,

FIG. 2 is a schematic showing a payment authorization message in accordance with the subject disclosure.

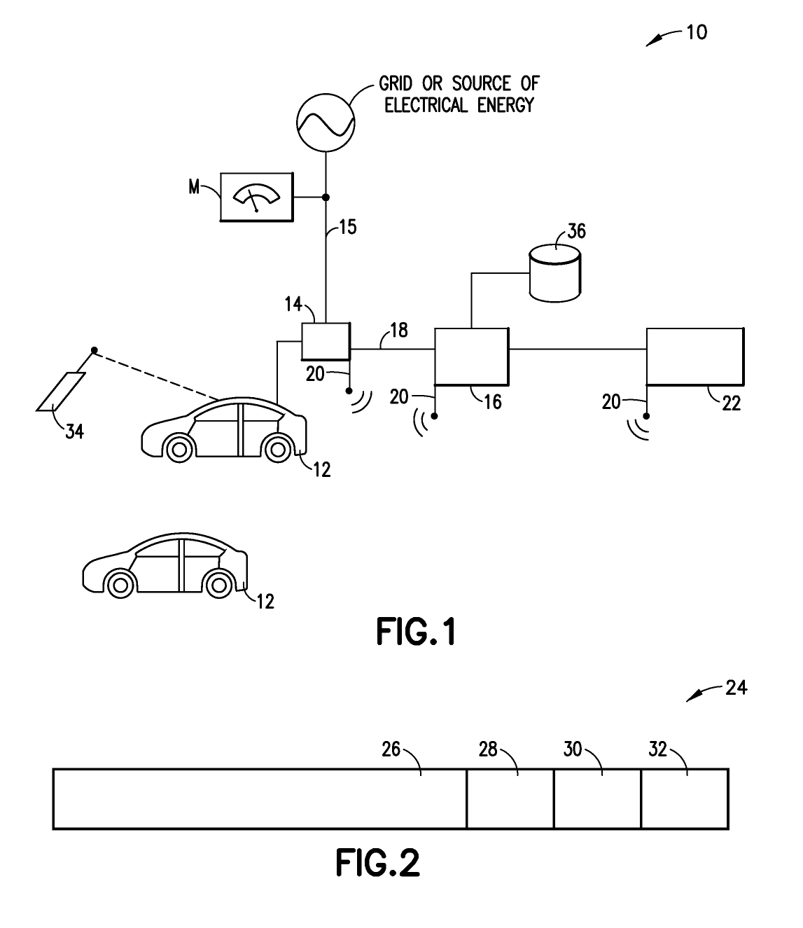

### DETAILED DESCRIPTION OF THE DISCLOSURE

A system 10 is provided herein for facilitating buying from, and selling electrical power to, electrically-powered vehicles 12. The system 10 generally includes an interface 14, for coupling with one or more of the electrically-powered vehicles 12, and a controller 16.

As will be recognized by those skilled in the art, the system 10 may be used with any electrically-powered vehicle 12, such as cars, trucks, buses, motorcycles, all-terrain vehicles, and so forth, that utilizes electrical power in whole or in part to power the transmission of the vehicle. The electrically-powered vehicles 12 typically include a port to which a charge cable may be coupled. In addition, software may be provided in the electrically-powered vehicles 12 which provides details of the electrical power status of the vehicle 12 (e.g., available power, state of charging) and/or at least some control over the charging process (e.g., start/stop).

The interface 14 is configured to couple with the electrically-powered vehicles 12, such as through a port. The vehicles 12 and the interface 14 may include any pins, jacks, plugs, and the like for hard-wired connection and/or may be configured for wireless and/or inductive coupling. The coupling arrangement may be in various combinations with male elements and female elements being provided on the vehicles 12 and the interface 14 in various combinations.

A transmission line 15 may be coupled with the interface 14. The transmission line 15 is configured to pass two-way flow of electricity therethrough both to and from the interface 14. The transmission line 15 is coupled to a grid or other source of electrical energy. Any form of metering equipment, e.g., meter M, may be utilized to measure the amount of electrical energy being transmitted over the transmission line 15 to or from the electrically-powered vehicles 12 during a charging or discharging session.

The controller 16 resides on one or more CPU's. The controller 16 may reside on a payment network 22 or be linked thereto (hard-wired, wirelessly). The interface 14 may be hard wired to the controller 16 and/or the payment network 22 via a line 18 and/or may be wirelessly coupled to the controller 16 and/or the payment network 22 by receivers/transmitters 20 using any known transmission standards.

The controller 16 is configured to receive data as one or more sets of data elements. The data elements are formatted to be transmitted with a payment authorization message 24 over the payment network 22. A payment authorization message transmitted over a payment network must be in a compatible form. Certain data elements of the payment authorization message are pre-defined to include basic transaction information, such as a user's credit or debit account, merchant information, transaction amount, and so forth. In addition, a payment authorization message may include additional data elements which are left blank to allow for additional information to be transmitted with transaction. For example, MasterCard Worldwide provides its own private data subelements (PDS's) that provide additional character spaces (e.g., alphanumeric, punctuation spaces) to accommodate additional details of a transaction beyond the standard details which are transmitted (e.g., as defined by the ISO 8583 specifications). With reference to FIG. 2, one or more standard data elements 26 may be included with the payment authorization message 24. The standard data elements 26 include the standard information transmitted with the payment authorization message 24, such as user's credit or debit account, merchant information, transaction amount, and so forth.

With the subject disclosure, it is preferred that a first set of data elements 28 be provided with the payment authorization message 24 configured to represent a number of electrical units (e.g., kilowatt-hours, BTU's, joules) being sent to, or transmitted from, the electrically-powered vehicle 12 when coupled to the interface 14. A second set of data elements 30 may be also provided which represent a price per unit of electrical power sent to, or transmitted from, the electrically-powered vehicle when coupled with the interface 14. Further, a third set of data elements 32 may be provided which represent whether electrical power is being sent to, or transmitted from, the electrically-powered vehicle 12 when coupled with the interface 14. All of the data elements 28, 30, 32 are formatted to be transmitted with the payment authorization message 24 over the payment network 22. The data elements 28, 30, 32 may include designated fields representing particular values (e.g., whole numbers and decimals) where the fields collectively represent the overall value or representation. For example, the first set of data elements 28 may include fields for representing whole number and decimal values, which taken together provide an indication of the relevant number of electrical units.

With the subject disclosure, the payment authorization message 24 may be generated by the electrically-powered vehicle 12, the interface 14 and/or an apparatus located along the transmission line 15. During a charging session, electrical power will be caused to flow through the transmission line 15, through the interface 14 and into an electrical storage element (e.g., battery) of the electrically-powered vehicle 12 coupled to the interface 14. The amount of electrical energy and its associated price may be determined by software on the electrically-powered vehicle 12 (e.g., by a built-in electrical meter and wireless determination of current price) with the payment authorization message 24 being subsequently generated by the electrically-powered vehicle 12 to pay for the charging session. The payment authorization message 24 may be transmitted to the interface 14, e.g., through a data connection, and then transmitted to the payment network 22, either directly or through the controller 16. The amount and price of the electrical energy provided to the electrically-powered vehicle 12 may be determined by the interface 14 and/or an apparatus along the transmission line 15, e.g., by using the meter M, and wireless determination of current price. These details may be transmitted to the electrically-powered vehicle 12 coupled to the interface 14 with the payment authorization message 24 being subsequently generated. In addition, the amount and price of the electrical energy may be provided (e.g., wirelessly) directly to the electrically-powered vehicle 12, e.g., by an operator of the interface 14 and/or the transmission line 15 with the electrically-powered vehicle 12 subsequently generating the payment authorization message 24. As a further alternative, the payment authorization message 24 need not include an amount to be charged, thereby eliminating the need to obtain and transmit the price per unit of electrical energy. The price may be separately provided during the processing of the payment authorization message 24, e.g., based on time and day of the charging session.

It is noted that the electrically-powered vehicle 12 may be operatively linked with an ancillary device 34, such as a cellular-capable and/or web-enabled device (e.g., smartphone, computer). The details of a charging session may be transmitted to the ancillary device 34 which transmits the payment authorization message 24. The ancillary device 34 may be provided with application software, or the like, configured to set parameters, control (stop/start) and/or monitor receipt or transmission of electrical power with respect to the electrically-powered vehicle 12.

Once transmitted, the payment authorization message 24 is processed on the payment network 22 in accordance with standard procedures. Clearance of the payment authorization message 24 allows for payment for the purchase of a certain amount of electrical energy. The system 10 may be used at a user's home, thereby allowing a user to pay for each discrete transaction, and/or as a distributed network allowing for utilization by multiple users over a region, including away from users' homes.

The payment authorization message 24 may be used as a transmission of data, without acting as a request for payment authorization. For example, electrical power may be transmitted from the electrically-powered vehicle 12 and through the transmission line 15, via the interface 14, as essentially a sale of electrical power from the electrically-powered vehicle 12 onto the grid powering the transmission line 15. The payment authorization message 24 may be generated to reflect the particulars of this sale by including the amount of electrical power which was transmitted (the first set of data elements 28). The payment authorization message 24 may include the standard information discussed above thereby creating an association between the first set of data elements 28 as a sale and a particular account, e.g., as defined by a user's credit or debit account. The third set of data elements 32 may be included as a flag that the payment authorization message 24 represents a sale rather than a purchase of electrical energy. The corresponding price, as discussed above, may be determined and included in the payment authorization message 24 or may be determined afterwards, e.g., based on time and date of the transaction. The payment authorization message 24 may be received by the controller 16, either directly or through the payment network 22. The controller 16 may be configured to parse the payment authorization request 24 to determine the information related to the first, second and third sets of data elements 28, 30, and 32. In this manner, a database 36 may be linked to the controller 16 in which user accounts may be established. The database 36 may be used to track the amounts of electrical energy sold by a user along with relevant pricing. This allows for establishing credits, based on electrical energy transmitted to the grid, with such credits being used to offset cost of one or more later purchases of electrical energy. In addition, or alternatively, the database 36 may be used as a source of data which allows for evaluating the commodity-type market of vehicle-related electrical power. The database 36 may be also used to track purchases of electrical energy sent to the electrically-powered vehicle 12.

The electrically-powered vehicle 12, or an ancillary device 34 operatively linked thereto, may be configured to monitor electrical energy pricing and activate a sale of electrical power (i.e., transmission from the electrically-powered vehicle 12) based on pre-set parameters (e.g., time of day, particularly price, etc.). Price monitoring may be done wirelessly (e.g., periodic polling) or through hard-wired connection. In this manner, the electrically-powered vehicle 12 may be coupled to the interface 14 with electrical energy only passing therebetween upon a command issued by the electronically-powered vehicle 12 and/or the ancillary device 34. This allows for a person to leave the electrically-powered vehicle 12 (e.g., during work) coupled, or able to be coupled with, the interface 14 with a charging and/or discharging session being conducted upon command, which may be manually activated and/or may be auto-activated as a result of pre-set parameters. The electronically-powered vehicle 12 may be charged and discharged at various times during a given time interval such as a work day.

What is claimed is:

1. A payment authorization message formatted to be transmitted over a payment network, said payment authorization message including data elements in electronic form representing units of electrical power sent to, or transmitted from, an electrically-powered vehicle.

2. A payment authorization message as in claim 1, further comprising a second set of data elements representing a price per unit of electrical power sent to, or transmitted from, an electrically-powered vehicle.

3. A payment authorization message as in claim 2, further comprising a third set of data elements representing whether electrical power is being sent to or transmitted from an electrically-powered vehicle.

4. A payment authorization message as in claim 1, further comprising a second set of data elements representing whether electrical power is being sent to or transmitted from an electrically-powered vehicle.

5. A buy/sell system for electrical power for electrically-powered vehicles, said system comprising:
an interface for coupling with an electrically-powered vehicle, said interface allowing for two-way flow of electricity to and from an electrically-powered vehicle coupled with said interface; and,
a controller for receiving data elements in electronic form formatted to be transmitted with a payment authorization message over a payment network, said data elements representing units of electrical power sent to, or transmitted from, an electrically-powered vehicle coupled with said interface.

6. A system as in claim 5, further comprising a transmission line coupled with said interface, said transmission line configured to pass two-way flow of electricity therethrough.

7. A system as in claim 6, further comprising a meter to measure amounts of electricity being transmitted over said transmission line.

8. A system as in claim 5, wherein said data elements including a second set of data elements formatted to be transmitted with a payment authorization message over a payment network, said second set of data elements representing a price per unit of electrical power sent to, or transmitted from, an electrically-powered vehicle coupled with said interface.

9. A system as in claim 8, wherein said data elements including a third set of data elements formatted to be transmitted with a payment authorization message over a payment network, said third set of data elements representing whether electrical power is being sent to or transmitted from an electrically-powered vehicle coupled with said interface.

10. A system as in claim 5, wherein said data including a second set of data elements formatted to be transmitted with a payment authorization message over a payment network, said second set of data elements representing whether electrical power is being sent to or transmitted from an electrically-powered vehicle coupled with said interface.

11. A system as in claim 5, wherein said controller is configured to parse said data elements.

12. A system as in claim 11, further comprising a database for tracking, on an user-account basis, amounts of electricity being bought or sold by an user.

13. A system as in claim 5, further comprising a database for tracking, on an user-account basis, amounts of electricity being bought or sold by an user.
